(19) United States
(12) Patent Application Publication
(10) Pub. No.: US 2004/0172451 A1
(43) Pub. Date: Sep. 2, 2004

(54) System and method for sharing digital images

(76) Inventors: Nigel Biggs, Guildford (GB); Mike Stroud, Guildford (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/374,528

(22) Filed: Feb. 27, 2003

(51) Int. Cl. G06F 15/16

(52) U.S. Cl. 709/206

(57) ABSTRACT

A system and method for sharing one or more digital image files comprises sending the image files from a sender's computer to a central server. The image files are stored at a central data store associated with the central server, and reduced size files (“thumbnails”) are generated at the central server from the image files. An email message to a recipient is generated, to which are attached the thumbnails and an HTML link to the central server. The email message is then sent to the recipient.

### FIELD OF THE INVENTION

The present invention generally relates to a system and method for sharing digital images. More specifically, it relates to a system and method for sending imaging data via e-mail to a client computer having a browser operably connected to a web server.

### BACKGROUND OF THE INVENTION

With the growth in the use of digital cameras and mobile phones having picture-taking capabilities, it has become common for users to send digital pictures via email. The sender locates the files that he wishes to send or share and “attaches” them to an email. An email client on the sender's computer uploads the email text message, together with the attached files, to an email server. The email and attached files are then sent to the recipient's email server, and downloaded from there to an email client on the recipient's computer. Generally the attached files are sent untouched and in the same state as they were originated.

Digital pictures are frequently very large files, and may be encoded in a variety of formats, such as a bitmap (BMP) or compressed format (e.g. JPG). Bitmap (BMP) files are uncompressed digital picture files and can easily be 20 MB or more, although typical end user digital camera files generally use a compressed format (JPG) where the typical file size may be as low as 200-500 KB. Pictures produced by modern high resolution cameras may be 2 MB each, or more, even when compressed.

It will be appreciated that, when pictures are shared by email, very large amounts of data need to be transferred. Even with the smallest files described above it will be apparent that to share 10 pictures occupying 300 KB each (for example) requires the transfer of 3 MB of data.

As described above, when sending such files by email, the sender has to upload the files to his email server. This can be time-consuming and laborious, especially if he has a slow connection to the server.

The recipient of the e-mail does not have any control as to whether or not an e-mail having large files attached is delivered to him. The recipient will thus have to download huge files before he knows whether he really wants to see the pictures or not.

As an alternative, many service providers offer the facility of an “online album” or web-based sharing site. A user uploads the files he wishes to share to the sharing site, and is provided with a username and password. He emails the username and password to potential viewers, who can then access the site and view the pictures for themselves. The user again needs to upload all his images to the sharing site as full size files, which is again time-consuming and laborious. Emailing the username and password to potential viewers requires a further, separate action. Each recipient of this email has no idea if he really wants to see the shared pictures until he has gone online to view the pictures.

### SUMMARY OF THE INVENTION

It is an object of the present invention to provide a system and method for enabling a potential recipient of shared pictures to make an informed decision as to whether or not he wishes to view the pictures before he downloads large image files. It is a further object of the invention to provide a system and method to reduce the time needed to upload image files to a central server.

The present invention enables the sender to share digital pictures directly and online with a much reduced upload time and with a single integrated email preparation.

In accordance with one aspect of the present invention, a method for sharing digital picture files is provided in which image files are sent to a central server and stored at a central data store. Reduced size image files are generated at the central server from the image files and attached to an email message sent from the central server to a recipient. The email message also contains an HTML link to the central server so that the recipient can view the image files stored at the central data store.

The email received by the recipient has attached thereto reduced size image files (or “thumbnails”) of the original images. It is therefore quick to download and the recipient does not have to wait a long time to download images he may not wish to see. The thumbnails allow the recipient the opportunity of deciding whether or not he would like to view any of the pictures at screen size. If so, he can follow the HTML link to the central server and download the screen size image files from the central data store. The thumbnails may be 100×75 pixels in size.

Preferably, the step of uploading the image files to the central server is performed in the sender's computer by client software obtained from the operator. The client software may also operate on the digital image files before they are uploaded so that they are in a suitable format. This operation preferably reduces the size of the digital image files. A suitable size for the image files to be uploaded to the central server is the size of a computer monitor screen—usually 640×480 pixels. An alternative is to use image files in the region of 480×360 pixels, which would be the size of a large window approximately three quarters of the size of the screen.

Since the client software operates on the image files before upload to the central server so as to reduce their size, the upload time is greatly reduced. The resolution lost by reducing the size of the images will not be noticed by a recipient viewing the final picture, since if the picture contained more than 640×480 pixels this would not be visible on a normal computer monitor screen anyway.

It is possible that the recipient might wish to print the pictures after downloading them, so the sender may have the option of preventing the reduction in size of the pictures uploaded to the central server.

The client software preferably associates the prepared image files with a text message (provided by the sender) before sending them to the central server. This text message is then included in the email sent to the recipient.

The thumbnails and the HTML link to the central server are preferably embedded in the email message to the recipient. This means that the email received by the recipient includes the thumbnails as part of the message. Each thumbnail is preferably associated with an HTML link to the corresponding image file stored at the central data store, meaning that if the recipient clicks on a thumbnail his browser retrieves the corresponding image file from the central data store.

Some email systems do not support HTML emails, so the thumbnails are preferably also stored in the central data store, and an indication included in the email message as to where the thumbnails can be found.

Preferably the email message includes promotional messages relating to the operator. These may include HTML links to a website maintained by the operator.

Preferred embodiments of the invention allow for a plurality of operators, each maintaining a central server. The client software may contain information as to which operator has supplied the client software, in which case the method further includes the step of contacting a server director to determine the central server to which the image files should be sent, the server director selecting the central server on the basis of which operator supplied the client software to the sender. This allows a number of operators to use identical software, but customise it so that to the end user it is branded by operator.

In accordance with another aspect of the present invention there is provided a system for sharing digital image files, comprising a central server for receiving and distributing image files and a central data store associated with the central server for storing image files. Client software is installed on a sender's computer for associating a text message with digital image files and sending the text message and image files to the central server. Software is operated by the central server to store the image files received from the sender in the central data store, generate reduced size image files from the received image files, associate the reduced size image files with HTML links to the corresponding image files in the central data store, generate an email message to a recipient including the text message, attach the reduced size image files and associated HTML links to the email message, and send the email message to the recipient.

In accordance with a yet further aspect of the invention, there is provided a method for storing and distributing digital image files, comprising receiving digital image files and recipient information from a sender and storing the digital image files in a central data store. Thumbnails are generated from the received digital image files, and an HTML link to the corresponding digital image file is associated with each thumbnail. An email message to a recipient is generated and sent, having attached thereto the thumbnails and associated HTML links.

The invention also provides a computer program arranged to carry out any of the methods described above.

It will be appreciated that the term “computer” as used above is intended to include any processing device which can acquire, store, process or send digital images. It may therefore include a PC, mobile phone, pda, digital camera etc.

### BRIEF DESCRIPTION OF THE DRAWINGS

So that the manner in which the features of the present invention are attained and can be understood in detail, a more particular description of the invention, briefly summarized above, may be had by reference to the appended drawings. It is to be noted, however, that the appended drawings illustrate only typical embodiments of this invention and are therefore not to be considered limiting of its scope, for the invention may admit to other equally effective embodiments.

FIG. 1 is an architectural diagram of a network system in which the present invention can be implemented.

FIG. 2 is a block diagram showing the processes performed by elements of the network of FIG. 1.

FIG. 3 is a flow chart showing the processes involved in uploading one or more digital image files to a server.

FIG. 4 is a flow chart showing the processes involved in generating an email message to the recipient.

FIG. 5 is a flow chart showing the actions available to the recipient of the email message.

### DESCRIPTION OF THE PREFERRED EMBODIMENT

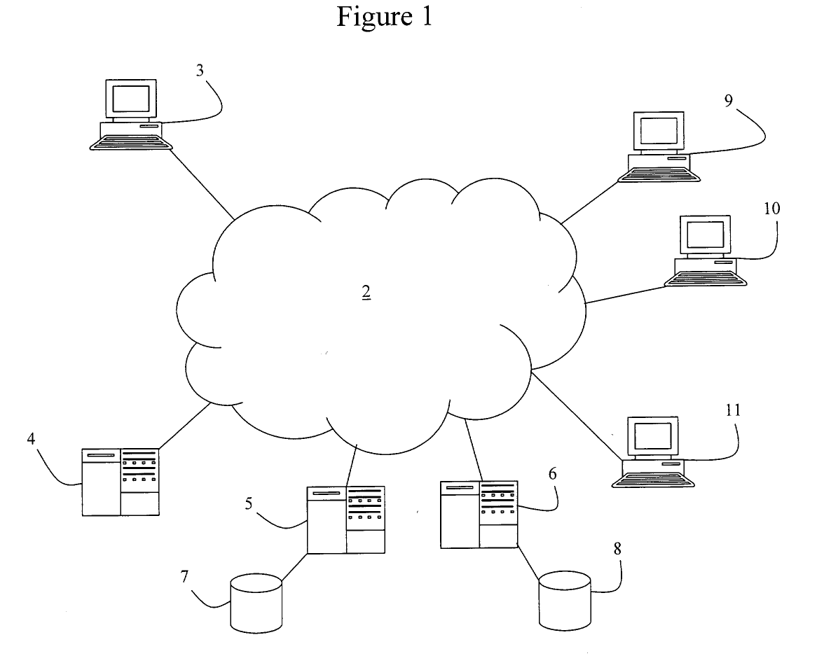

FIG. 1 shows a network 1 having elements which can communicate with each other via the Internet 2. The network 1 includes a sender's computer 3, Pmail server director 4, brand Pmail servers 5, 6, Pmail data stores 7, 8 and recipient computers 9, 10, 11. As will become apparent, the word “Pmail” as used herein is intended to indicate both a text message associated with image files sent from the sender 3 to a Pmail server 5, 6, and an email message with thumbnails attached sent from a Pmail server 5, 6 to a recipient 9, 10, 11.

The facility to share pictures may be provided by more than one operator, each maintaining an independent Pmail server 5, 6 and Pmail data store 7, 8. Initially, a user accesses the Pmail server 5 of an operator, and downloads branded client software. The client software works in the same way whichever operator is chosen, but is branded for the specific operator from which it is downloaded. A brand ID is built into the client software and will be used later to determine which Pmail server should be used to handle each application.

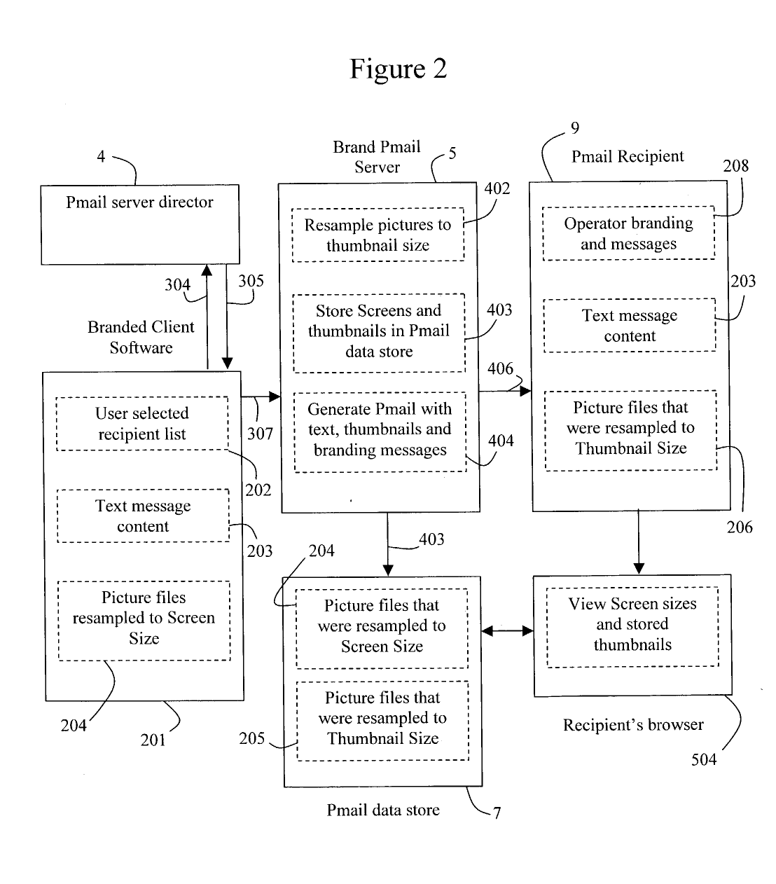

It will be appreciated that the client software need not be downloaded from the operator's Pmail server itself but can be obtained from any of a number of sources associated with that operator—for example from another website maintained by the operator, or on a CD sold with a digital camera. The client software 201 is installed on the sender's computer 2, as shown in FIG. 2.

The branded client software 201 appears to the user to be similar to a typical email system. When the software is started the user is presented with the opportunity to view a list of “Pmails” which have already been sent, or any unsent (draft) Pmails. The user may choose to send (or re-send) any of these. Alternatively the user may choose to generate a new Pmail.

If the user chooses to generate a new Pmail, he is presented with a generic “email” preparation window containing fields for the recipients' email addresses, a link to an address book, space for a text message and an area which will show the images to be sent. He enters the recipients' email addresses 202 into the relevant window, types whatever text message he wishes the recipient to receive 203 (as for an ordinary email) and attaches the image files he wishes to send.

Images can be attached either via an “Insert Pictures” button (which opens up an Explorer type window) or directly by dragging and dropping them from another imaging application. When the client software is used as part of a suite of programs, images selected in an image management part can be automatically copied to the client software when the sharing application is run. When images are inserted into the Pmail they are displayed as thumbnails in the Pmail preparation window.

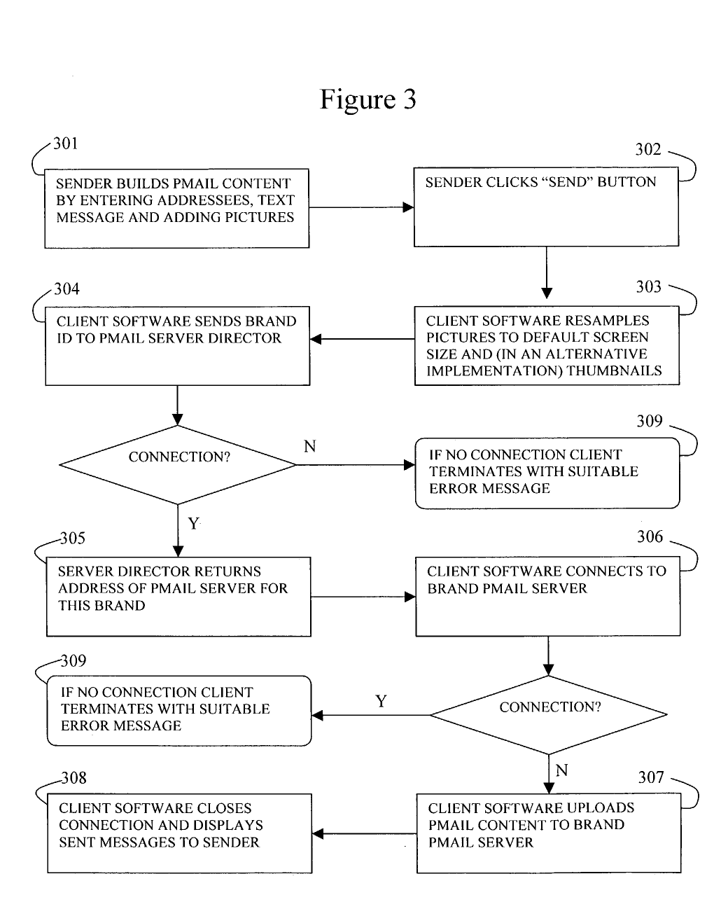

When ready, the user indicates to the software that the Pmail should be sent. FIG. 3 shows the process now followed by the client software 201.

Following preparation 301 of the Pmail and the instruction to send 302, the client software prepares the Pmail by resampling the images 303 to a desired “screen” size 204, and saving as a JPG file, typically 640×480 pixels or 480×360 pixels. A JPG at 480×360 pixels occupies approximately 33 KB. The size to which images are to be resampled may also be configured by the user, if he wishes to ensure that the pictures received are at a higher resolution.

As shown also in FIG. 2, the client software 201 then sends its brand ID 304 to the Pmail server director 4. The Pmail server director 4 returns the address 305 of the brand Pmail server 5 used by the operator which originally provided the client software. The client software contacts 306 the Pmail server 5 and uploads the Pmail content 307 to the brand Pmail server. When this process is completed the client software moves the sent Pmail to a “sent” folder 308 on the sender's computer.

If the server director 4 or the brand Pmail server 5 cannot be contacted, the “Send” process is terminated with a suitable error message to the user 309.

In an alternative implementation, the client software may also generate thumbnail sizes (100×75 pixels) and send these to the Pmail server as well as the resampled “screen size” images. This reduces the workload on the central Pmail server at the cost of a small increase in upload content from each sender.

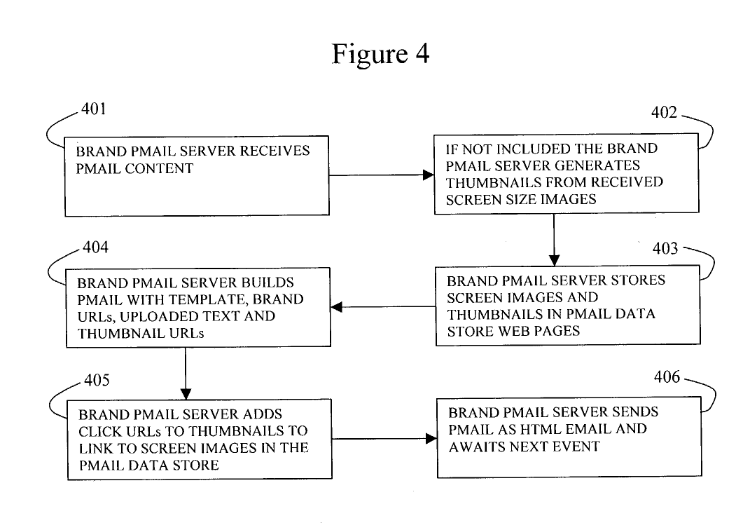

The procedure followed by the Pmail server 5 is shown in FIG. 4, together with FIG. 2. The Pmail server 5 receives 401 the Pmail text 203, screen size images 204, sender identity and email address and recipient email addresses 202. In an alternative implementation the Pmail server receives thumbnail images as well.

If the Pmail server 5 did not receive any thumbnails, it generates thumbnail size images 402 (typically 100×75 pixels) from the screen size images and stores both 403 in the Pmail data store 7 under an account related to the sender's name and email address. The thumbnail images are again JPGs, and are approximately 3 KB in size.

The Pmail server 5 builds an email 404 (still termed a Pmail) including the sent text, HTML links to display the thumbnail images and HTML links to relevant brand images and messages. The server 4 adds click-links 405 to each thumbnail pointing back to its related screen size image 204 in the Pmail data store 7.

The Pmail server 5 sends the Pmail to the recipient addresses 406. The screen size images 204 are kept in the data store 7 for a pre-determined and configurable length of time (typically 30 days).

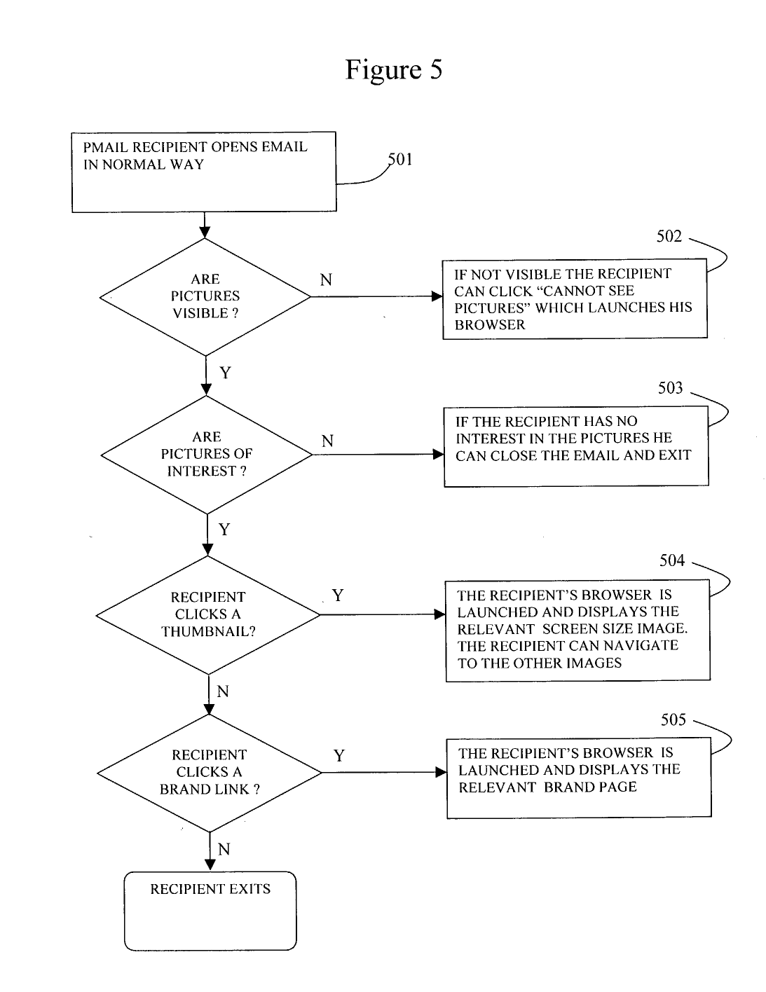

Each recipient 9, 10, 11 receives an email 501 with the embedded HTML links. The process now-followed is shown in FIG. 5, with reference also to FIG. 2. Not all email systems support HTML emails, so a message is included in the Pmail telling the recipient to “Click here” if no pictures can be seen. A click on “Click here” starts the recipient's browser 502 and connects to the thumbnails 205 stored in the Pmail data store 7.

Normally in the email the recipient sees thumbnail versions 206 of all the sent pictures together with the sent text 203 and the operator's branding and messages 208. The recipient has the immediate benefit that he can decide that the thumbnails 206 provide sufficient information, and that he has no need to link to a web site 503.

If the recipient wishes to see a larger version of a sent image he clicks on any thumbnail 206 in the email. The recipient's browser 504 is started, accesses the Pmail data store 7, and displays the appropriate web page containing the screen size image 204 relating to the clicked thumbnail 206.

The recipient can use his browser to navigate to all the other screen size images and to a page containing the image thumbnails 205.

A click on the branding 208 usually starts the recipient's browser and links him to predetermined pages on the operator's web site 503. This enables the operator to provide useful links for the recipient in the Pmail, together with advertisements for his own services. This ability to insert easily changeable links into the email provides an advantage for the operator, since emails containing image files sent directly by users will not contain this information. Similarly, emails sent by users to recipients containing user names and passwords for online albums will not include branding links.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1. A method for sharing one or more digital image files, said method comprising:
sending the image files from a sender's computer to a central server;
storing the image files at a central data store associated with the central server;
generating reduced size image files at the central server from the image files;
generating an email message to a recipient;
attaching the reduced size image files, and an HTML link to the central server, to the email message; and
sending the email message to a recipient.

2. The method of claim 1, further comprising operating client software on the sender's computer, the client software operating on the digital image files to prepare them in a format suitable for the central server and sending the prepared image files to the central server.

3. The method of claim 2, wherein the operation of the client software on the digital image files reduces the size of the digital image files.

4. The method of claim 3, wherein the size of the prepared image files is chosen so that they fill the screen of a computer monitor.

5. The method of claim 3, wherein the size of the prepared image files is 480×360 pixels.

6. The method of claim 2, wherein the client software allows the sender to specify the size of the prepared image files to be sent to the central server.

7. The method of claim 2, wherein the client software associates the prepared image files with a text message before sending them to the central server.

8. The method of claim 7, wherein the email message sent to the recipient includes the text message associated with the prepared image files.

9. The method of claim 2, wherein the client software is obtained from the operator of the central server.

10. The method of claim 9, wherein the client software is downloaded from the central server.

11. The method of claim 9, wherein a plurality of operators each maintain a central server and the client software contains information as to which operator has supplied the client software, the method further comprising:
contacting a server director to determine the central server to which the image files should be sent, the server director selecting the central server on the basis of which operator supplied the client software to the sender.

12. The method of claim 1, wherein the reduced size image files and the HTML link to the central server are embedded in the email message to the recipient.

13. The method of claim 12, wherein each reduced size image file in the email message is associated with an HTML link to the corresponding image file stored in the central data store.

14. The method of claim 13, further comprising opening a browser at the recipient's computer in response to an HTML link associated with a reduced size image file, and viewing the corresponding image file using the browser.

15. The method of claim 1, further comprising:
storing the reduced size image files in the central data store;
associating with each stored reduced size image file an HTML link to the corresponding image file; and
including in the email message to the recipient a thumbnail HTML link to the stored reduced size image files.

16. The method of claim 15, further comprising:
at the recipient's computer, opening a browser to follow the thumbnail HTML link;
viewing the stored reduced size image files using the browser; and
following the HTML link associated with a stored reduced size image file to view the corresponding stored image file using the browser.

17. The method of claim 1, wherein each reduced size image file is 100×75 pixels.

18. The method of claim 1, wherein the central server is maintained by an operator and the email message sent to the recipient includes promotional messages for the operator.

19. The method of claim 18, wherein the promotional messages include HTML links to a website maintained by the operator.

20. A system for sharing digital image files, comprising:
a central server for receiving and distributing image files;
a central data store associated with the central server for storing image files;
client software installable on a sender's computer for associating a text message with digital image files and sending the text message and image files to the central server; and
software operable by the central server for storing the image files received from the sender in the central data store, generating reduced size image files from the received image files, associating the reduced size image files with HTML links to the corresponding image files in the central data store, generating an email message to a recipient including the text message, attaching the reduced size image files and associated HTML links to the email message, and sending the email message to the recipient.

21. A method for storing and distributing digital image files, comprising:
receiving digital image files and recipient information from a sender;
storing the digital image files in a central data store;
generating reduced size image files from the received digital image files;
associating with each reduced size image file an HTML link to the corresponding digital image file stored at the central data store;
generating an email message to a recipient;
attaching to the email message the reduced size image files and associated HTML links; and
sending the email message to the recipient.

22. The method of claim 21, further comprising storing the reduced size image files in the central data store.

23. The method of claim 22, further comprising including in the email message an HTML link to the reduced size image files in the data store.

24. A method of sending a digital image file from a sender's computer to a central server, comprising:
installing client software on the sender's computer;
operating the client software so as to generate a reduced size image file from the digital image file and send the reduced size image file to the central server.

25. The method of claim 24, further comprising downloading the client software from the central server.

26. A computer program arranged when executed to carry out the method of claim 21.

27. A computer program arranged when executed to reduce the size of a digital image file and send a reduced size image file to a central server.

28. A computer storage medium having stored thereon the computer program of claim 26.

29. A system for sharing digital image files, said system comprising:
central server means for receiving and distributing image files;
central data storage means associated with the central server means for storing image files;
associating means for associating a text message with digital image files, and for sending the text message and digital image files to the central server means; and
instruction means operable by the central server for storing the image files received from the sender in the central data storage means, for generating reduced size image files from the received image files, for associating the reduced size image files with HTML links to the corresponding image files in the central data storage means, for generating an e-mail message to a recipient including the text message, for attaching the reduced size image files and associated HTML links to the e-mail message, and for sending the e-mail message to the recipient.

30. A system for storing and distributing digital image files, said system comprising:
receiving means for receiving digital image files and recipient information from a sender;
storing means for storing the digital image files in a central data storage means;
generating means for generating reduced size image files from the received digital image files;
associating means for associating with each reduced image file an HTML link to the corresponding digital image file stored at the central data storage means;
generating means for generating an e-mail message to a recipient;
attaching means for attaching to the e-mail message the reduced size image files and associated HTML links; and
sending means for sending the e-mail message to the recipient.
